(19) United States
(12) Patent Application Publication
(10) Pub. No.: US 2016/0272041 A1
(43) Pub. Date: Sep. 22, 2016

(54) DAMPER OPENING AND CLOSING MECHANISM FOR VEHICLE AIR-CONDITIONING DEVICE

(71) Applicant: MITSUBISHI HEAVY INDUSTRIES AUTOMOTIVE THERMAL SYSTEMS CO., LTD., Kiyosu-shi, Aichi (JP)

(72) Inventors: Tsubasa YAMASHITA, Aichi (JP); Takahide YAMAMOTO, Aichi (JP)

(73) Assignee: MITSUBISHI HEAVY INDUSTRIES AUTOMOTIVE THERMAL SYS TEMS CO., LTD., Kiyosu-shi, Aichi (JP)

(21) Appl. No.: 15/034,093

(22) PCT Filed: Dec. 3, 2014
(86) PCT No.: PCT/JP2014/082037

§ 371 Date: May 3, 2016

(30) Foreign Application Priority Data
Dec. 5, 2013 (JP) 2013-252266

(51) Int. Cl. B60H 1/00; F16K 31/524

(52) U.S. Cl. CPC B60H 1/00671; F16K 31/524; B60H 2001/00707

(57) ABSTRACT

Provided is a damper opening and closing mechanism for a vehicle air-conditioning device which is capable of enlarging the operation space when servicing the damper opening and closing mechanism and improving the service maintainability or making the air-conditioning device more compact. This damper opening and closing mechanism for the vehicle air-conditioning device is provided with: a link plate in which a cam groove is provided along an arc-shaped outer peripheral region, a center portion of which is rotatably supported on the lateral surface of a case; and an actuator which is fixedly disposed on the outer surface side of the link plate and which drives the link plate to rotate. A center region of the link plate rotatably supported on the lateral surface of the case is shifted toward a side distant from the actuator by a predetermined dimension S with respect to the outer peripheral region where the cam groove is provided, and one surface of the actuator is accommodated and disposed in the shifted center region.

### TECHNICAL FIELD

The present invention relates to a damper opening and closing mechanism for a vehicle air-conditioning device in which a damper, such as a blow-out mode damper, can be opened and closed via a link plate that is driven to rotate by an actuator.

### BACKGROUND ART

In a vehicle air-conditioning device, a plurality of dampers, such as blow-out mode dampers, are coordinated with each other to open and close sequentially at a predetermined timing. Such a vehicle air-conditioning device has a configuration in which a link plate rotated by an actuator or a manual operation, and pins of a plurality of turning levers, each of which is joined to a damper shaft, are fitted into a cam groove provided along an outer peripheral region of the link plate. Further, in such a vehicle air-conditioning device, a damper opening and closing mechanism is adopted which is capable of opening and closing the dampers sequentially at the predetermined timing by rotating the link plate as required.

In such a damper opening and closing mechanism, when a link plate, which is rotatably supported with respect to a lateral surface of a case of a heating ventilation and air-conditioning unit (HVAC unit), is configured to be rotatable by the actuator, it is typical that the actuator is fixedly disposed on the outer surface of the link plate, and an output shaft of the actuator is fitted to a rotating shaft of the link plate, as disclosed in Patent Document 1, for example. In this case, the actuator is configured to be removable in a direction orthogonal to the lateral surface of the case.

### CITATION LIST

### Patent Literature

Patent Document 1: Japanese Examined Utility Model Application Publication No. H5-25291Y

### SUMMARY OF INVENTION

### Technical Problem

As disclosed in the Patent Document 1, the damper opening and closing mechanism for the vehicle air-conditioning device is normally provided on the lateral surface of the case of the HVAC unit. On the other hand, a blower unit is integrally disposed on one side of the HVAC unit. As the air-conditioning unit is getting more compact, a space (gap) between the HVAC unit and the blower unit tends to become significantly narrower. Thus, only a space that is just wide enough for an adult hand to fit through is provided as the above-described gap, so when servicing the damper opening and closing mechanism, it is extremely difficult to attach and detach the actuator.

More specifically, in the damper opening and closing mechanism provided on the lateral surface of the case of the HVAC unit, the link plate has a disc-shape, and the position of the turning lever fitted into the cam groove is identified. Thus, when the link plate surface including the cam groove is considered as a reference surface, a protrusion dimension of the damper opening and closing mechanism from the lateral surface of the case of the damper opening and closing mechanism is determined by the thickness-direction dimension of the actuator fixedly disposed on the outer surface of the reference surface. Therefore, if the above-described gap is narrowed further to make the air-conditioning unit more compact, it is inevitable that the space for attaching and detaching the actuator cannot be secured, which indicates a challenge as to how to secure the space for attaching and detaching the actuator.

In light of the above, an object of the present invention is to provide a damper opening and closing mechanism for a vehicle air-conditioning device that is capable of enlarging the operation space when servicing the damper opening and closing mechanism and of improving the service maintainability or making an air-conditioning unit more compact.

### Solution to Problem

In order to solve the above-described problem, a damper opening and closing mechanism for a vehicle air-conditioning device according to the present invention adopts the following means.

According to a first aspect of the present invention, a damper opening and closing mechanism for a vehicle air-conditioning device includes a link plate including an arc-shaped outer peripheral region and a center portion, the outer peripheral region including a cam groove, the center portion being rotatably supported on a lateral surface of a case of an HVAC unit; and an actuator fixedly disposed on the lateral surface of the case on an outer surface side of the link plate, the actuator being configured to drive the link plate to rotate. The damper opening and closing mechanism is capable of opening and closing a damper via a turning lever including a pin fitted into the cam groove of the link plate, a center region of the link plate rotatably supported on the lateral surface of the case is shifted toward a side distant from the actuator by a predetermined dimension with respect to the outer peripheral region including the cam groove, and one surface of the actuator is accommodated and disposed in the shifted center region.

According the above-described damper opening and closing mechanism for a vehicle air-conditioning device of the first aspect of the present invention, when a surface of the outer peripheral region including the cam groove of the link plate is considered as a reference surface (a surface determined by the position of the turning lever that rotates the damper), as a result of accommodating and disposing the one surface of the actuator in the center region shifted from the reference surface, it is possible to fixedly dispose the actuator at a position closer to the lateral surface of the case by a dimension corresponding to the offset dimension. Therefore, a space formed on the outer side of the actuator is enlarged. As a result, it is possible to improve the serviceability by simplifying the attachment and detachment of the actuator, or when the space formed on the outer side of the actuator is kept constant, it is possible to reduce a gap between the actuator and an adjacent blower unit and to reduce the width of the air-conditioning unit by the offset dimension.

In the above-described damper opening and closing mechanism for the vehicle air-conditioning device, the center region may be defined, by a circular arc-shaped stepped portion corresponding to the offset dimension, as a region in which the actuator does not come into contact with the outer peripheral region when the link plate is rotated.

According to the above-described configuration, even when the link plate is rotated around the axis center of a rotating shaft thereof by the actuator, there is no risk that the actuator. the one surface of which is accommodated and disposed in the center region, comes into contact with the outer peripheral region, thereby allowing the link plate to freely rotate within a set range. Therefore, by accommodating and disposing the one surface of the actuator in the center region of the link plate and by reducing the thickness-direction dimensions of the link plate and the actuator, it is possible to enlarge the space formed on the outer side of the actuator by the offset dimension.

In any one of the above-described damper opening and closing mechanisms for the vehicle air-conditioning device, the actuator may be fixedly disposed on the outer surface side of the link plate via a mounting boss passing through a circular arc-shaped long hole provided in the link plate, and the center region may include the whole circular arc-shaped long hole.

According to this configuration, when the actuator is fixedly disposed on the outer surface side of the link plate, it is essential to adopt a configuration in which the circular arc-shaped long hole is provided in the link plate, and the mounting boss passes through the long hole. Disposing the whole circular arc-shaped long hole in the center region makes it possible to achieve an offset structure without making the configuration of the link plate unnecessarily complex. Therefore, implementing a simple structural improvement of the link plate makes it possible to enlarge the space formed on the outer side of the actuator, without cost increase. As a result, it is possible either to improve the service maintainability or to reduce the width of the air-conditioning unit.

### Advantageous Effects of Invention

According to the present invention, when the surface of the outer peripheral region including the cam groove of the link plate is considered as a reference surface (a surface determined by the position of the turning lever that rotates the damper), as a result of accommodating and disposing the one surface of the actuator in the center region shifted from the reference surface, it is possible to fixedly dispose the actuator closer to the lateral surface of the case by a dimension corresponding to the offset dimension. Therefore, the space formed on the outer side of the actuator is enlarged. As a result, it is possible to improve the serviceability by simplifying the attachment and detachment of the actuator, or, when the space formed on the outer side of the actuator is kept constant, it is possible to reduce a gap between the actuator and an adjacent blower unit and to reduce the width of the air-conditioning unit by the offset dimension.

### BRIEF DESCRIPTION OF DRAWINGS

FIG. 1 is a front view of main components of a vehicle air-conditioning device according to an embodiment of the present invention.

FIG. 2 is a cross-sectional view taken along A-A in FIG. 1.

FIG. 3 is a front view of a link plate assembly of a damper opening and closing mechanism illustrated in FIG. 2.

FIG. 4 is a cross-sectional view taken along B-B in FIG. 3.

### DESCRIPTION OF EMBODIMENTS

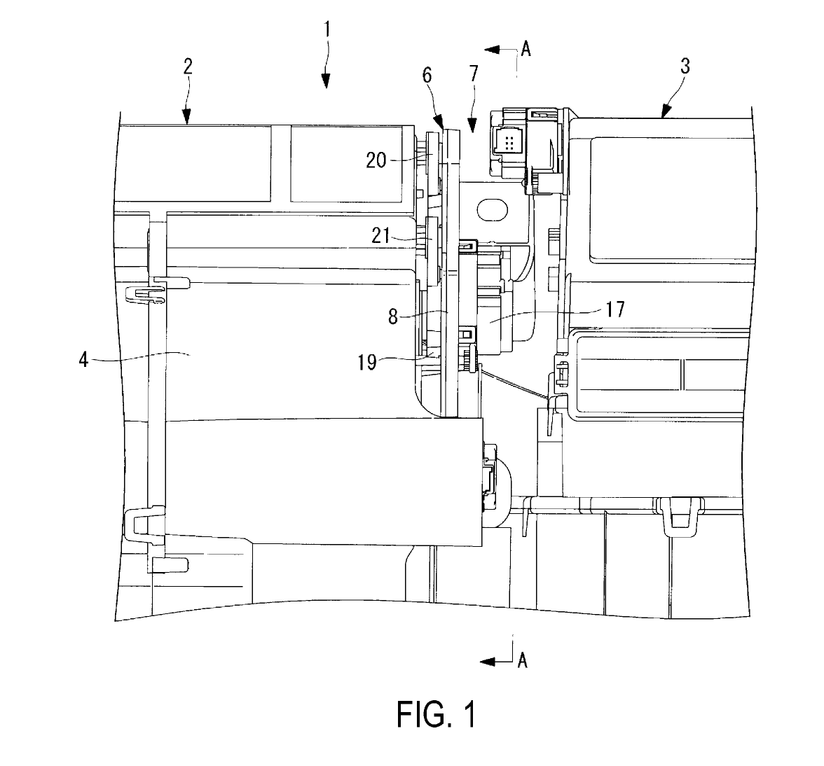

An embodiment of the present invention will be described below with reference to FIGS. 1 to 4.

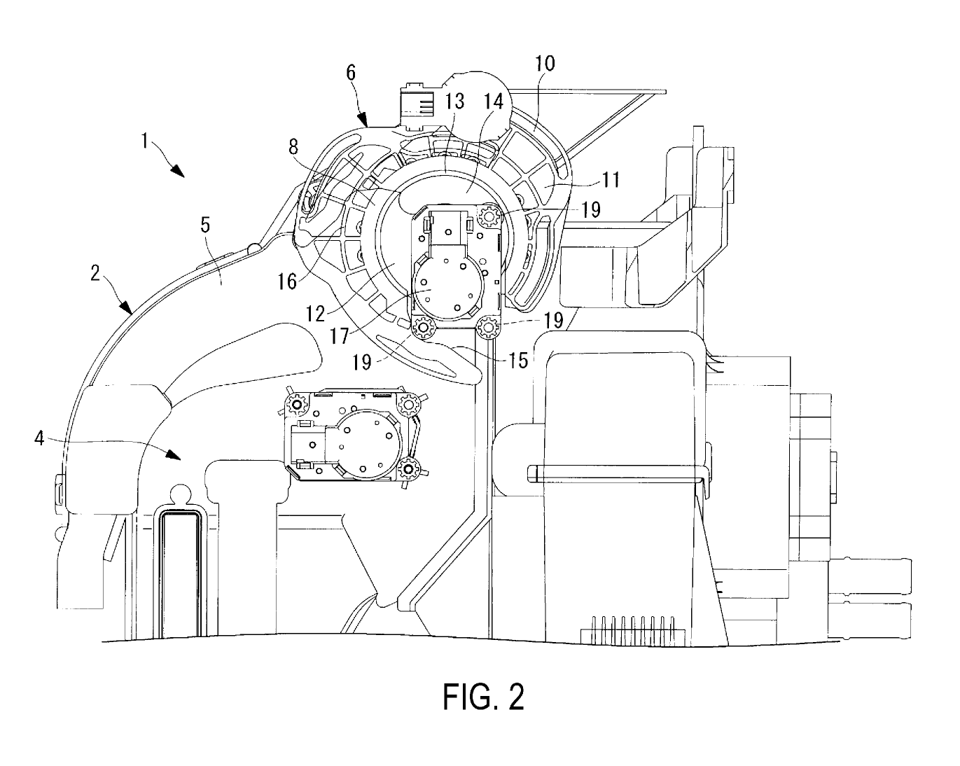

FIG. 1 is a front view of main components of a vehicle air-conditioning device according to an embodiment of the present invention. FIG. 2 is a cross-sectional view taken along A-A in FIG. 1.

A vehicle air-conditioning device (hereinafter also simply referred to as an AC unit) 1 includes a heating ventilation and air-conditioning unit (HVAC unit) 2 and a blower unit 3 disposed adjacent to one side of the HVAC unit 2 and integrally joined to the HVAC unit 2.

As publicly known, the HVAC unit 2 is provided with a built-in evaporator and heater core. After adjusting the temperature of the air inside the vehicle cabin (inside air) or the temperature of the outside air supplied from the blower unit 3 to a set temperature, the HVAC unit 2 controls the temperature inside the vehicle cabin by blowing out the air selectively from one or more of a plurality of air vents that are open toward the vehicle cabin. The HVAC unit 2 is integrally joined to the blower unit 3 and installed in an instrument panel provided in the front side of the vehicle cabin. A plurality of blow-out mode dampers are arranged in a plurality of defroster air vents, foot air vents, and face air vents. The plurality of blow-out mode dampers are configured to be able to open and close in accordance with a blow-out mode set by a damper opening and closing mechanism 6, which will be described below.

As publicly known, the blower unit 3 is provided with a blower, such as a centrifugal blower driven by a motor, and an inside/outside air switching unit that causes the inside air or the outside air to be sucked into the blower. Further, the air vent of the blower unit 3 is connected to the HVAC unit 2 at a position on the upstream side of the evaporator. As a result, the blower unit 3 is configured such that the inside air or the outside air sucked thereinto via the inside/outside air switching unit can be supplied to the HVAC unit 2.

The HVAC unit 2 having an air flow channel formed therein is provided with a unit case 4 disposed in the air flow channel and including the evaporator, the heater core, the various dampers, and the like. The damper opening and closing mechanism 6, which opens and closes the plurality of blow-out mode dampers, is provided on a lateral surface 5 of the unit case 4. As a result of this damper opening and closing mechanism 6 being provided on the lateral surface 5 located toward the blower unit 3, which is disposed close to and integrally joined to the HVAC unit 2, the damper opening and closing mechanism 6 is installed in an extremely narrow gap 7. Due to a growing demand to make the AC unit 1 more compact in recent years, the gap 7 between the HVAC unit 2 and the blower unit 3 is getting narrower and narrower. Currently, only a space that is just wide enough for an adult hand to fit through is secured as the gap 7.

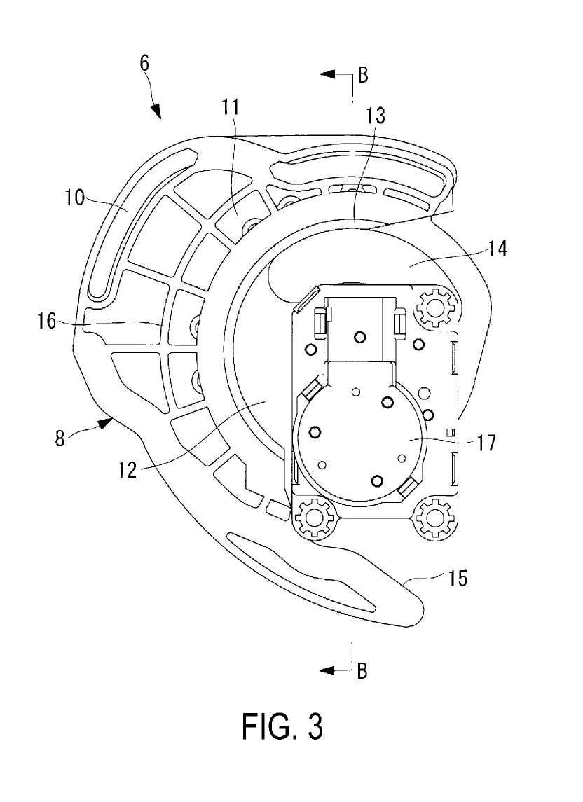

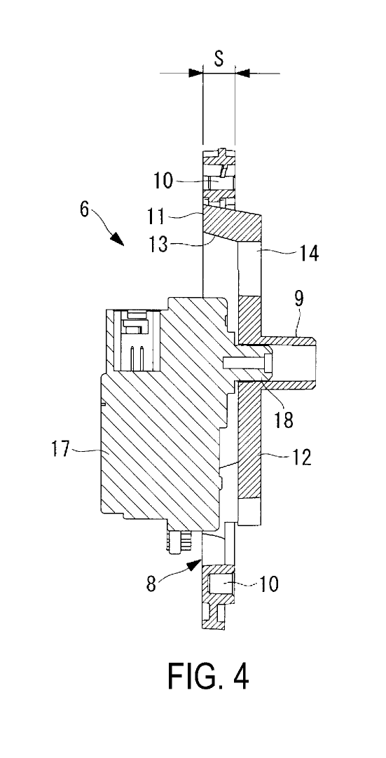

The present invention relates to the damper opening and closing mechanism 6 that opens and closes dampers, such as the above-described blow-out mode dampers. FIG. 3 is a front view of a link plate assembly of the damper opening and closing mechanism 6. FIG. 4 is a cross-sectional view taken along B-B in FIG. 3. The configuration of the damper opening and closing mechanism 6 will be described below in detail.

The damper opening and closing mechanism 6 is provided with a link plate 8, a rotating shaft portion 9 of which is rotatably supported on the lateral surface 5 of the unit case 4, which corresponds to a section in which the blow-out mode dampers are provided. The damper opening and closing mechanism 6 further includes an actuator (stepping motor) 17 that is fixed on the outer surface side of the link plate 8 and that drives the like plate 8 to rotate by being directly connected to the rotating shaft portion 9 of the link plate 8.

The link plate 8 has a disc-shape, and the rotating shaft portion 9 protrudes from the center portion on the inner surface of the link plate 8. Further, a plurality of cam grooves 10 or one continuous cam groove 10 is provided along an arc-shaped outer peripheral region 11. This disc-shaped link plate 8 is configured such that the outer peripheral region 11 including the cam groove 10, and a center region 12 including the rotating shaft portion 9 are shifted in position from each other in the axial direction by a predetermined dimension S. The outer peripheral region 11 and the center region 12 are integrally formed via a circular arc-shaped stepped portion 13 corresponding to the offset dimension S.

The center region 12 shifted by the dimension S toward the inner surface (the side distant from the actuator 17), has a size such that one surface of the actuator 17 can be accommodated and disposed in center region 12. Further, the circular arc-shaped stepped portion 13 that defines the center region 12 has a radius such that the actuator 17 is prevented from coming into contact with the outer peripheral region 11 when the link plate 8 is rotated. Further, in the link plate 8, an circular arc-shaped long hole 14 is provided in the center region 12 along the circular arc-shaped stepped portion 13, through which a mounting boss 19 protruding from the lateral surface 5 of the unit case 4 passes, and part of the outer peripheral region 11 is shaped so as to form a notch 15 for the mounting boss 19. Further, the outer peripheral region 11 is provided with a multiplicity of reinforcing ribs 16.

Meanwhile, the actuator (stepping motor) 17 is fixed by being fastened using screws or the like from the outer side to the plurality of mounting bosses 19 protruding outward from the lateral surface 5 of the unit case 4, resulting in the actuator 17 being fixedly disposed on the outer surface side of the link plate 8. An output shaft 18 of the actuator 17 is directly connected to the link plate 8 by being fitted into a center hole of the rotating shaft portion 9 of the link plate 8, which enables the link plate 8 to rotate about the rotating shaft portion 9.

Further, pins that are provided on the distal ends of turning levers 20 and 21 (see FIG. 1) integrally joined to damper shafts of the above-described blow-out mode dampers are slidably fitted in the cam groove 10 of the link plate 8 to be rotated by the actuator 17. The pins are configured to rotate via the cam groove 10 at a predetermined timing in response to the rotation of the link plate 8, thereby rotating the damper shafts so as to open and close the blow-out mode dampers.

According to the above-described configuration, the present embodiment has the following effects.

In the damper opening and closing mechanism 6, when the actuator (stepping motor) 17 is driven on the basis of an instruction from a control device, the link plate 8, which is directly connected to the output shaft 18 of the actuator 17, is driven to rotate about the rotating shaft portion 9, thereby rotating the plurality of turning levers 20 and 21 that are fitted into the cam groove 10 of the link plate 8 via the pins thereof. Accordingly, the plurality of damper shafts are driven to rotate, causing the plurality of blow-out mode dampers to open and close the defroster air vents, the foot air vents, and the face air vents as appropriate. Further, the blow-out mode is selectively switched to one of a face mode, a foot mode, a defroster mode, a bi-level mode, and a defroster and foot mode. As a result, the temperature inside the vehicle cabin can be controlled by blowing out the air, which is temperature-controlled by the HVAC unit 2, into the vehicle cabin.

At the service maintenance of the damper opening and closing mechanism 6, the actuator 17 is detached to the outer side by inserting a hand through the gap 7 between the HVAC unit 2 and the blower unit 3 and removing the screws. However, the space is an extremely narrow that is just wide enough for an adult hand to fit through.

Therefore, in the present embodiment, the link plate 8, which forms the damper opening and closing mechanism 6, is configured such that the center region 12, which is rotatably supported on the lateral surface 5 of the unit case 4 via the rotating shaft portion 9, is shifted toward a side distant from the actuator 17 by the predetermined dimension S with respect to the outer peripheral region 11, which includes the cam groove 10. Further, the link plate 8 is configured such that the one surface of the actuator 17 is accommodated and disposed in the shifted center region 12.

Thus, when one lateral surface of the outer peripheral region 11 including the cam groove 10 of the link plate 8 is considered as a reference surface (a surface determined by the positions of the turning levers 20 and 21 that rotate the dampers), as a result of accommodating and disposing the one surface of the actuator 17 in the center region 12 shifted from the reference surface by the dimension S, it is possible to fixedly dispose the actuator 17 closer to the lateral surface 5 of the unit case 4 by a dimension corresponding to the offset dimension S.

As a result, the space for the gap 7 formed on the outer side of the actuator 17 is enlarged, and consequently, it is possible to improve the serviceability by simplifying the attachment and detachment of the actuator 17. Alternatively, when the gap 7 formed on the outer side of the actuator 17 is kept constant, it is possible to reduce a gap between the actuator 17 and the adjacent blower unit 3 and to reduce the width dimension of the AC unit 1 by the offset dimension S.

Further, the above-described center region 12 has a radius such that the actuator 17 does not come into contact with the outer peripheral region 11 when the link plate 8 is rotated. Furthermore, the center region 12 is defined by the circular arc-shaped stepped portion 13 which is a step corresponding to the offset dimension S. Therefore, even when the link plate 8 is rotated about the rotating shaft portion 9 by the actuator 17, there is no risk that the actuator 17, the one surface of which is accommodated and disposed in the center region 12, comes into contact with the outer peripheral region 11, thereby allowing the link plate 8 to freely rotate within a set range.

Accordingly, it becomes possible to accommodate and dispose the one surface of the actuator 17 in the center region 12 of the link plate 8 and to reduce the thickness-direction dimension of the link plate 8 and the actuator 17 in the axial direction, namely, the thickness-direction dimension of the damper opening and closing mechanism 6. As a result, it is possible to enlarge the space for the gap 7 formed on the outer side of the actuator 17 by the offset dimension S, or, when the size of the gap 7 is kept constant, to make the AC unit 1 smaller by reducing the width of the AC unit 1 by the dimension S.

Further, in the present embodiment, a configuration is adopted in which the actuator 17 is fixedly disposed on the outer surface side of the link plate 8 via the mounting bosses 19, which pass through the circular arc-shaped long hole 14 provided in the link plate 8, and the center region 12 is formed so as to include the whole circular arc-shaped long hole 14. Thus, when the actuator 17 is fixedly disposed on the outer surface side of the link plate 8, it is essential to adopt a configuration in which the circular arc-shaped long hole 14 is provided in the link plate 8, and the mounting bosses 19 pass through the circular arc-shaped long hole 14. Further, disposing the whole circular arc-shaped long hole 14 in the center region 12 makes it possible to achieve an offset structure without making the configuration of the link plate 8 unnecessarily complex.

Therefore, implementing a simple structural improvement of the link plate 8 makes it possible to enlarge the space for the gap 7 formed on the outer side of the actuator 17 without cost increase. As a result, it is possible either to improve the service maintainability or to reduce the width of the AC unit 1.

Note that the present invention is not limited to the invention according to the above-described embodiment and can be modified as required without departing from the spirit of the present invention. For example, in the above-described embodiment, an example has been described in which the present invention is applied to the damper opening and closing mechanism 6 that opens and closes the blow-out mode dampers. However, it is needless to say that the present invention may be applied not only to the damper opening and closing mechanism for the blow-out mode dampers, but also to a damper opening and closing mechanism for other types of dampers, such as air mix dampers or inside and outside air switching dampers used for temperature control, for example.

Further, although description has been given of the link plate 8 having the disc-shape, the disc-shape does not necessarily mean a circular shape. The contour of the link plate 8 is shaped so as to have raised and recessed sections due to differences or changes in the dimension of the cam groove 10 in the radial direction, and it is needless to say that the link plate 8 does not always have the same shape, but has various shapes depending on the shape of the cam groove.

### REFERENCE SIGNS LIST

1 Vehicle air-conditioning device (AC unit)
2 HVAC unit
4 Unit case
5 Lateral surface
6 Damper opening and closing mechanism
8 Link plate
9 Rotating shaft portion
10 Cam groove
11 Outer peripheral region
12 Center region
13 Circular arc-shaped stepped portion
14 Circular arc-shaped long hole
17 Actuator
18 Output shaft
19 Mounting boss
20, 21 Turning lever
S Offset dimension

1. A damper opening and closing mechanism for a vehicle air-conditioning device, the mechanism comprising:
a link plate including an arc-shaped outer peripheral region and a center portion, the outer peripheral region including a cam groove, the center portion being rotatably supported on a lateral surface of a case of an HVAC unit; and
an actuator fixedly disposed on the lateral surface of the case on an outer surface side of the link plate, the actuator being configured to drive the link plate to rotate;
the damper opening and closing mechanism being capable of opening and closing a damper via a turning lever, the turning lever including a pin fitted into the cam groove of the link plate;
a center region of the link plate rotatably supported on the lateral surface of the case being shifted toward a side distant from the actuator by a predetermined dimension with respect to the outer peripheral region including the cam groove; and
one surface of the actuator being accommodated and disposed in the shifted center region.

2. The damper opening and closing mechanism for the vehicle air-conditioning device according to claim 1, wherein
the center region is defined, by a circular arc-shaped stepped portion corresponding to the offset dimension, as a region in which the actuator does not come into contact with the outer peripheral region when the link plate is rotated.

3. The damper opening and closing mechanism for the vehicle air-conditioning device according to claim 1, wherein
the actuator is fixedly disposed on the outer surface side of the link plate via a mounting boss passing through a circular arc-shaped long hole provided in the link plate; and
the center region includes the whole circular arc-shaped long hole.

4. The damper opening and closing mechanism for the vehicle air-conditioning device according to claim 2, wherein
the actuator is fixedly disposed on the outer surface side of the link plate via a mounting boss passing through a circular arc-shaped long hole provided in the link plate; and
the center region includes the whole circular arc-shaped long hole.
